(19) United States
(12) Patent Application Publication
(10) Pub. No.: US 2011/0099547 A1
(43) Pub. Date: Apr. 28, 2011

(54) APPROACHES FOR INSTALLING SOFTWARE USING BIOS

(76) Inventor: Gaurav BANGA, Cupertino, CA (US)

(21) Appl. No.: 12/827,056

(22) Filed: Jun. 30, 2010

Related U.S. Application Data
(60) Provisional application No. 61/255,751, filed on Oct. 28, 2009.

(51) Int. Cl. G06F 9/445; G06F 15/16

(52) U.S. Cl. 717/176; 709/224

(57) ABSTRACT

Approaches for installing software, configuration changes, or content on a machine using BIOS residing thereon. BIOS executing on a client contains an injector module, which is a component detects whether a bootstrap program is installed on the client, and, barring a valid reason for the absence of the bootstrap program, installs the bootstrap program on the client. The bootstrap program is a software program, stored by the operating system of the client, which determines whether an OS component program is installed and executing on the client, and, barring a valid reason for the absence of the OS component program, installs the OS component program on the client. The OS component program monitors the actions of the user of the client to ascertain whether any legitimate changes have been made to the software programs installed thereon and installs any additional desired software, configuration changes, or content on the client.

### RELATED APPLICATIONS

This application claims priority to U.S. provisional patent application Ser. No. 61/255,751, filed Oct. 28, 2009, by Dr. Gaurav Banga, the disclosure of which is incorporated by reference for all purposes as if fully set forth herein.

### FIELD OF THE INVENTION

The present invention relates to approaches for installing software on a machine using BIOS residing thereon.

### BACKGROUND OF THE INVENTION

The use of computers, especially portable computers such as laptops or personal digital assistants (PDAs), has become popular in recent years. Many companies provide their employees with a computer to assist with the performance of their job responsibilities. It is desirable for a company to ensure that the computers used by their employees be installed with an approved set of software. For example, a company may wish to ensure that each company laptop executes a virus protection program, an asset tracking program, and one or more software programs selected to assist in the performance of the employee's responsibilities. While a company may issue corporate guidelines requesting that employees not remove, disable, or erase corporate software installed on corporate computers, certain employees may, either intentionally or unintentionally, nevertheless fail to comply with such a policy. Unfortunately, such unauthorized tampering may lead to operational problems with their computer, such as the prevention of (a) the automated installation of patches or updates to software or (b) the desirable execution of certain software programs, such as virus protection and corporate asset tracking programs.

The unauthorized removal or tampering with software pre-installed on a device may result in lost revenue for the original equipment manufacturers (OEMs) who receive compensation based on the number of computers supplied by the OEM that have certain software known as “after market software” or “OEMware.” Such removal or tampering with the OEMware may result in the removal of OEM or machine specific drivers and/or utilities that are necessary for the best operation of a computer system. Such OEM or machine specific drivers and/or utilities may not be present in off the shelf, after market versions of the operating system installed on the computer system. Therefore, if the operating system on the computer is reinstalled using an off the shelf operating system, it is possible that the OEM or machine specific drivers and/or utilities would not be installed on the computer system.

While approaches exist that work at the operating system level to protect changes to the system configuration of a computer, such as the types of undesirable changes described above, these approaches are quite fragile and generally easy to work around; for example, a user with administrative privileges on a computer system can generally make arbitrary changes to the computer system's configuration.

### FUNCTIONAL OVERVIEW

Approaches for installing software, multimedia content, and/or configuration changes on a machine using BIOS residing thereon are provided. The software installed on the machine using embodiments of the invention may be for any purpose. For example, the BIOS may install software using certain embodiments directed towards one or more of: security, asset tracking and inventory, user applications, operating system and application program updates, virus protection, and electronic content (such as purchased music, books, video, etc.). The configuration changes made by embodiments of the invention may correspond to one or more of changes to the configuration of software installed on the machine or changes to the configuration of hardware components of the machine. Embodiments of the invention may also be used to configure the web browser's preferred search engine, and to install a wide variety of multimedia content to machines using embodiments of the invention, including but not limited to video, music, advertisements, games, and books.

The term BIOS is an acronym that stands for Basic Input/Output System. BIOS may, but need not, include Unified Extensible Firmware Interface (UEFI)/Extensible Firmware Interface (EFI) firmware. BIOS executing on a machine (or “client”) may contain an injector module. An injector module is a component that is capable of (a) detecting whether a bootstrap program is installed on the client, and (b) upon detecting that the bootstrap program is not installed on the client, barring a valid reason for the absence of the bootstrap program, installing the bootstrap program on the client. BIOS stores all the data necessary for the injector module to install the bootstrap program on the client. In this way, the client is assured to possess a bootstrap program. For example, even if the client is reimaged by reinstalling a new operating system on the client, thereafter the injector module will detect that the bootstrap program is not currently installed and will subsequently install the bootstrap program on the client.

The bootstrap program is a software program, stored by the operating system, that is responsible for (a) determining whether a software component, referred to herein as the OS component program, is installed and executing on the client, and (b) upon determining that the OS component program is not executing on the client, barring a valid reason for the absence of the OS component program, installing the OS component program on the client. The bootstrap program may download the data necessary to install the OS component program from a server or other external location accessible by a network, such as the Internet.

The OS component program monitors the actions of the user of the client to ascertain whether any legitimate changes have been made to the software programs installed thereon. Additionally, in an embodiment, the OS component program installs any additional software programs on the client which should be installed. To perform this function, the OS component program may periodically contact a server to determine whether the client should install any additional software programs. In turn, the server may provide the client (a) information about what, if any, additional software programs should be installed by the client and (b) any data necessary to install such software programs. To address certain privacy concerns, the identity of the user of the client need not be identified to the server. Also, the OS component program need not reinstall any software programs that were legitimately uninstalled. In certain embodiments of the invention, the OS component program may be configured to install configuration changes and/or multimedia content to the client instead of or in addition to software programs.

Advantageously, when a software program installed on the client is removed, disabled, or erased in an illegitimate or unauthorized fashion, the software program may be automatically reinstalled on the device. Thus, even if a malicious user would attempt to circumvent the security provided by a client by installing a new hard-disk drive in the client, installing a new operating system on the existing hard-disk drive, or uninstalling or disabling individual software programs installed on the client, embodiments of the invention would advantageously be able to reinstall those software programs on the client. Software programs that have been legitimately uninstalled need not be reinstalled by embodiments of the invention. Moreover, embodiments of the invention may be used to automatically and remotely install one or more software programs on a plurality of clients.

The approaches described herein are not meant to describe all the embodiments of the invention, as other embodiments of the invention may differ in their operation compared to the illustrative approaches discussed in this section.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a block diagram of a system for installing software using BIOS of a device according to an embodiment of the invention;

FIG. 2 is an illustration of execution states according to an embodiment of the invention;

FIG. 3 is an illustration of operational states of a client according to an embodiment of the invention; and

FIG. 4 is a block diagram that illustrates a computer system upon which an embodiment of the invention may be implemented.

### DETAILED DESCRIPTION OF THE INVENTION

Approaches for installing software, configuration changes, and/or multimedia content on a machine using BIOS residing thereon are described. In the following description, for the purposes of explanation, numerous specific details are set forth in order to provide a thorough understanding of the embodiments of the invention presented herein. It will be apparent, however, that the embodiments of the invention presented herein may be practiced without these specific details. In other instances, well-known structures and devices are shown in block diagram form in order to avoid unnecessarily obscuring the embodiments of the invention presented herein.

### System Overview

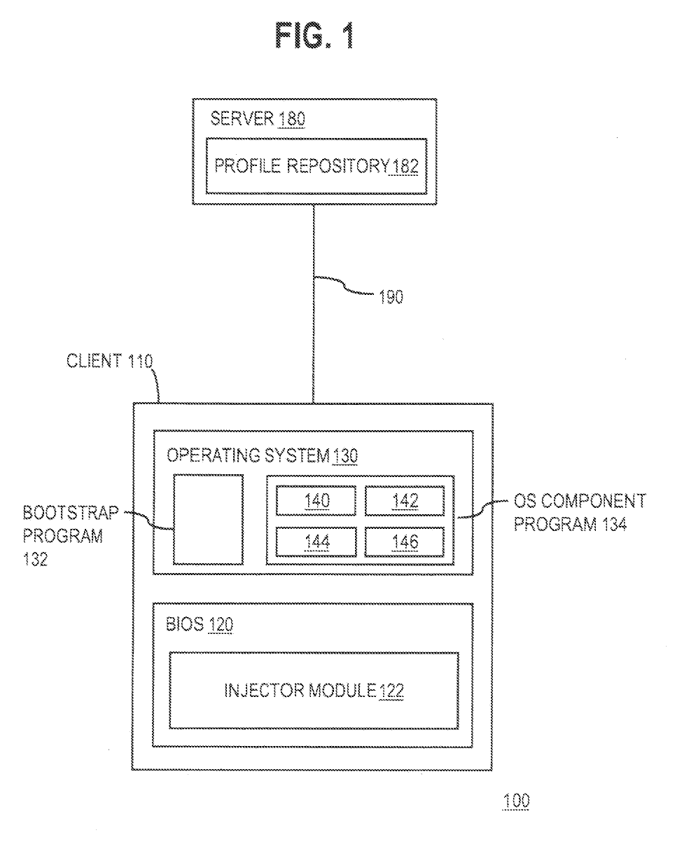

Prior to explaining the functional steps performed by an embodiment of the invention, a description of the components within an illustrative system will be provided. FIG. 1 is a block diagram of system 100 for installing software using BIOS 120 of client 110 according to an embodiment of the invention. While system 100 depicts a single client for clarity, other embodiments of the invention may include any number of clients.

Client 110, as broadly used herein, refers to any computerized device or machine which is capable of executing BIOS 120 and operating system 130. Typically, a client will be a portable device, such as a laptop, a personal digital assistant (PDA), a cell phone, a game system (such as an Xbox available from Microsoft Corporation of Redmond, Wash. or a PlayStation 3 available from Sony Corporation of Park Ridge, N.J.), or a tablet computer, although there are no size or weight restrictions of what may constitute a client. Thus, a client may be implemented using a relatively large, immobile, or cumbersome computerized device, such as a vending machine, a computerized gasoline dispenser, or an automatic teller machine (ATM). A client may execute any type of operating system, such as Vista from Microsoft Corporation of Redmond, Wash. or Linux.

Operating system 130 will provide a file system (not depicted) for storing and managing files and associated data thereon. The file system provided by operating system 130 is responsible for storing and retrieving files and associated data; thus, when operating system 130 is said to store data, it may do so by instructing the file system provided thereby.

BIOS 120 of client 110 may be implemented by firmware that is designed to be the first code executed by client 110 when client 110 is powered on. The initial function of BIOS 120 may be to identify, test, and initialize system devices such as the video display card, hard disk, floppy disk, and other hardware of client 110. BIOS 120 may prepare client 110 for a known state, so that software stored on a machine readable medium by client 110 can be loaded, executed, and given control of client 110. BIOS 120 may be implemented using BIOS technology available from Phoenix Technologies Ltd. of Milpitas, Calif., such as Phoenix SecureCore™.

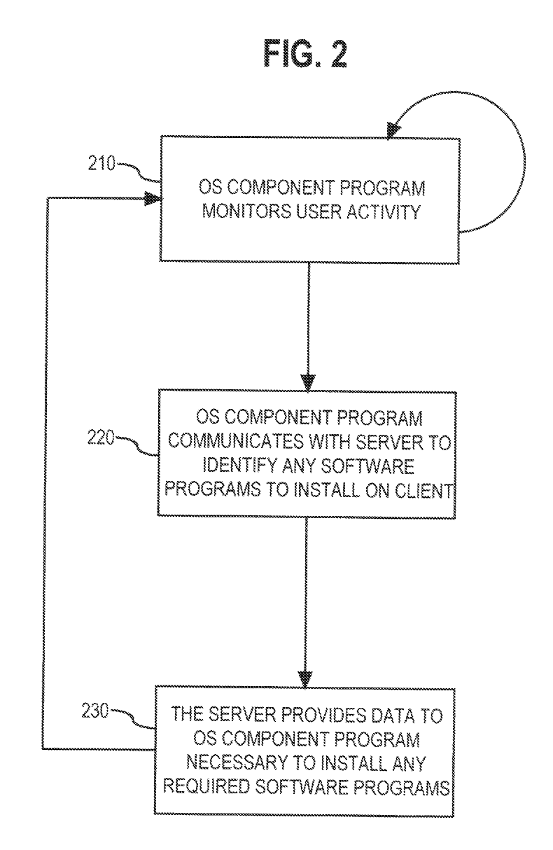

BIOS 120 may contain injector module 122. Injector module 122 is a component of BIOS 120 that is capable of (a) detecting whether bootstrap program 132 is installed on client 110, and (b) upon detecting that bootstrap program 132 is not installed on client 110, barring a valid reason for the absence of bootstrap program 132 on client 110, installing bootstrap program 132 on client 110. A valid reason for the absence of bootstrap program 132 on client 110 may include an exception given to the owner of client 110 (which may be used when the owner does not want to client 110 to perform the steps of FIG. 2 explained below). BIOS 120 stores all the data necessary for injector module 122 to install bootstrap program 132 on client 110. In this way, if client 110 lacks bootstrap program 132 for any reason (as would be the case if the hard-disk drive of client 110 has been reimaged by reinstalling a new operating system on client 110 or if a new hard-disk drive has been installed on client 110), injector module 122 will detect that bootstrap program 132 is not currently installed and will subsequently install bootstrap program 132 on client 110.

Bootstrap program 132 is a software program that is responsible for (a) determining whether a software component, referred to herein as OS component program 134, is installed and executing on client 110, and (b) upon determining that OS component program 134 is not executing on client 110, barring a valid reason for the absence of OS component program 134, installing OS component program 134 on client 110. Bootstrap program 132 may be designed to operate in and accommodate a variety of different file systems, such as NTFS and ext3. Bootstrap program 132 may download the data necessary to install OS component program 134 from server 180 or other external location accessible over communications link 190, such as the Internet. Bootstrap program 132 and OS component program 134 may be stored and executed by operating system 130.

In an embodiment, a version of OS component program 134 may be bundled with bootstrap program 132. In this way, injector module 122 may retrieve bootstrap program 132 and OS component program 134 together as a unit. In such an embodiment, bootstrap program 132 and OS component program 134 may both correspond to the same functional and/or structural component.

OS component program 134 monitors and tracks the actions of the user of client 110 to ascertain whether any legitimate changes are made to the software programs installed on client 110. Additionally, OS component program 134 is responsible for reinstalling any software programs on client 110 which should be reinstalled on client 110. To perform this function, periodically OS component program 134 may contact server 180 over communications link 190 to determine whether client 110 should install any software programs. In turn, server 180 may inform client 110 what, if any, software programs should be installed by client 110 as well as provide to client 110 any data necessary to install such software programs. OS component program 134 need not reinstall any software programs that were legitimately removed.

Server 180, as broadly used herein, may be implemented by any mechanism capable of communicating with client 110. Server 180 may be used to identify to client 110 which software programs client 110 should have installed as well as providing to client 110 any data necessary to install programs which client 110 should have installed.

The owner of client 110, or the vendor of client (i.e., the original equipment manufacturer (often abbreviated as OEM) that sold client 110 on the open market (which typically will be different than the owner of client 110, which is the purchaser of client 110)), may interact with server 180 to define a profile (hereafter an “installation profile” for client 110. An installation profile for a client identifies those software programs, configuration changes, and/or multimedia content items which the client should have installed. Thus, if the owner of client 110 wishes to update which software programs are installed on client 110, then the owner would contact server 180 (for example, via a GUI such as a web page) and update the installation profile for client 110. An installation profile for a client may be maintained, on server 180, in profile repository 182. Profile repository 182 represents any storage medium at or accessible to server 180. While profile repository is depicted in FIG. 1 as being part of or implemented on server 180, profile repository 182 may be implemented, in whole or in part, on a different physical machine than server 180. Profile repository 182 may store software installation profiles for any number of clients in system 100.

The owner or vendor of client 110 may establish one or more rules, within an installation profile, that server 180 uses in determining what should be installed upon a particular client. The one or more rules may consider a wide variety of information about a client. Each client sends information about itself to server 180 which may be referenced by a rule of an installation profile. Such information about a client may be organized into or otherwise associated with one or more profiles (such as a client hardware profile, a client software profile, a client user profile, and a client custom profile).

The information sent from client 110 to server 180 may be monitored, collected, and/or maintained at client 110 using one or more profile managers. A profile manager is an optional component which may or may not reside within OS component program 134. A profile manager is responsible for sending a certain type of information, about the client upon which it resides, to server 180. For example, in an embodiment, OS component program 134 may comprise hardware profile manager 140. Hardware profile manager 140 is an optional software component that is responsible for monitoring, collecting, and/or maintaining information about the hardware of client 110. For example, hardware profile manager 140 may provide information about a description of all the hardware within or attached to client 110, including version information, setting and/or configuration information for hardware of client 110.

In an embodiment, OS component program 134 may comprise software profile manager 142. Software profile manager 142 is an optional software component that is responsible for monitoring, collecting, and/or maintaining information about the software installed on client 110, including version information, setting and/or configuration information about software installed on client 110.

In an embodiment, OS component program 134 may comprise user profile manager 144. User profile manager 144 is an optional software component that is responsible for monitoring, collecting, and/or maintaining information about the user of client 110, and more specifically, how the user uses client 110, e.g., user profile manager 144 may collect statistics or information about which applications and/or hardware components a user executes on client 110 and the performance of client 110 in responding to the user's requests.

In an embodiment, OS component program 134 may comprise custom profile manager 146. Custom profile manager 146 is an optional software component that is responsible for monitoring, collecting, and/or maintaining a custom set of information about the client 110. The custom set of information which custom profile manager 146 sends to server 180 may be configured by the vendor or OEM of client 110, and this information may include any type of information (even information which might otherwise be collected by a different type of profile manager). The vendor or OEM of client 110 may periodically update the custom set of information monitored, collected, and/or maintained by custom profile manager 146.

Note that while four profile managers are depicted in FIG. 1 (namely 140, 142, 144, and 146), each is optional, and so embodiments of the invention may comprise any number or combination of profile managers, including none, all, or any number in-between. Also, the profile managers discussed herein are merely illustrative; other embodiments of the invention may employ profile managers which send different information about a client to server 180 or may combine multiple profile managers discussed herein into a single profile manager.

Communications link 190 may be implemented by any medium or mechanism that provides for the exchange of data between a client 110 and server 180. Non-limiting, illustrative examples of communications link 190 include, without limitation, a network such as a Local Area Network (LAN), Wide Area Network (WAN), Ethernet or the Internet, one or more terrestrial, satellite or wireless links, and serial or parallel printer cables.

### Installing a Software Program on a Client Using Bios Residing Thereon

FIG. 2 is a flowchart illustrating the functional steps of installing a software program, configuration setting, and/or multimedia content on client 110 using BIOS 120 according to an embodiment of the invention. In step 210, OS component program 134 monitors and tracks the activity of the user of client 110 to determine whether the user has removed or uninstalled a software program, driver, component of code, or any executable set of instructions. As shown by FIG. 2, OS component program 134 may continuously and/or repeatedly perform step 210.

In an embodiment, if the user of client 110 legitimately deletes a particular software program from client 110, then it may not be desirable to automatically reinstall the particular software program, but instead, respect the wishes of the user of client 110. On the other hand, if (a) a malicious user deletes or uninstalls one or more software programs from client 110 or (b) the intended user of client 110 purposefully deletes a software program against company policy or in an unauthorized manner, then it may be desirable to restore or reinstall those software programs on client 110.

In order to distinguish between a user of client 110 acting in an authorized manner and a user of client 110 acting in an unauthorized manner, certain embodiments of the invention may enable or require a user of client 110 to submit a “disable key” to OS component program 134 anytime the user requests the removal or configuration update of a software program installed on client 110 for the purpose of informing OS component program 134 that the current user is an authorized user and is performing a legitimate action on client 110. The disable key may be provided by the OEM to the owner of client 110, who may, in turn, communicate the disable key to an authorized user of client 110. The disable key may be implemented in a variety of ways, e.g., the disable key may be a password, code, token, and the like. Presumably, a malicious user, such as a thief, would not know or possess the disable key, and thus, would not be able to inform OS component program 134 that the action the user is about the take is a legitimate action by an authorized user. Similarly, an employee that is the intended user of client 110 would also not know or possess the disable key without the knowledge of the owner of client 110 (since the owner of client 110 is provided the disable key by the OEM, and thus, would need to share the disable key with the intended user of client 110), thereby minimizing the chance that the intended user of client 110 would modify client 110 against the wishes of the owner of client 110. OS component program 134 may monitor and record whether any change or removal of a software program was performed by an authorized user (i.e., the user successfully provided the disable key to OS component program 134) or an unauthorized user (i.e., the user did not provide the disable key to OS component program 134). Note that use of a disable key is optional, as not all embodiments of the invention may employ a disable key.

In an embodiment, when a user of client 110 deletes or uninstalls a particular software program installed on client 110, OS component program 134 persistently stores a record evidencing that the user of client 110 has removed or uninstalled the particular software program. There are several ways this may be accomplished. In one approach, OS component program 134 may persistently store within BIOS 120 a record that a user of client 110 removed or uninstalled a particular software program. Such a record may be implemented as a flag, e.g., a flag associated with a particular software program may initially have a value of “0,” but if a user removes or uninstalls the software program associated with the flag, the value of the flag is updated to “1.” Alternately, OS component program 134 may send to server 180, over communications link 190, notification that a user of client 110 has removed or uninstalled a particular software program from client 110. In such an approach, server 180 may persistently store a record that indicates that a user of client 110 removed or uninstalled the particular software program.

To address certain privacy concerns, embodiments of the invention may preserve the unanimity of the user of client 110 during operation. Thus, any record that indicates a user removed or uninstalled a software program may identify the particular client and the software program removed or uninstalled, but not the particular user that requested the removal. Similarly, any communication exchanged between client 110 and server 180 does not identify the identity of the human user of client 110, but instead, only identifies the particular client 110. Identifying client 110 without identifying the human user of client 110 may be performed in a variety of different ways, such as identifying a universal unique identifier (UUID) associated with client 110.

In certain embodiments, in step 210, any profile manager of OS component program 134 may monitor, collect, and/or maintain the information for which the profile manager is instructed to do so. In this way, information about a wide variety of characteristics of client 110 may be monitored, collected, and/or maintained in step 210. In an embodiment, a profile manager, such as user profile manager 144, may monitor records indicating the legitimate actions of the user of client 110.

In step 220, OS component program 134 sends a message to server 180 to determine what, if any, additional software programs, configuration settings, and/or multimedia content client 110 should have installed thereon. OS component program 134 may contact server 180 over communications link 190. If OS component program 134 is unable to contact server 180 over communications link 190 when OS component program 134 initially attempts to contact server 180, then OS component program 134 may periodically reattempt to contact server 180 over communications link 190 until communication is established.

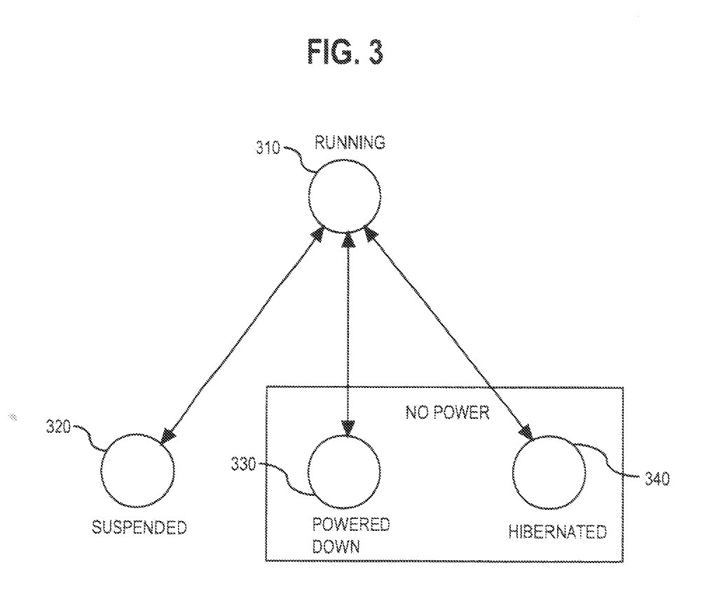

There are a variety of different trigger events for the performance of step 220. To illustrate how one embodiment may operate, consider FIG. 3, which is an illustration of operational states of a client according to an embodiment of the invention. As shown in FIG. 3, state 310 corresponds to when client 110 is running and fully operational, state 320 corresponds to when the operation of client 110 is suspended, state 330 corresponds to when client 110 is powered off, and state 340 corresponds to when client 110 is in hibernation mode. In states 330 and 340, client 110 receives no power, while in states 310 and 320, client 110 does receive power. In state 320, client 110 receives some power to store the current state of client 110 in memory. The states depicted in FIG. 3 may correspond to well recognized industry standard system power states, e.g., state 310 may correspond to S0, state 320 may correspond to S3, state 340 may correspond to S4, and state 330 may correspond to S5.

In an embodiment, step 220 is performed anytime client 110 transitions from state 340 to state 310. Thus, anytime client 110 is powered on from a powered off state, OS component program 134 contacts server 180 to determine what, if any, software programs, configuration settings, and/or multimedia content client 110 should have installed thereon in addition to those already installed. In such an embodiment, step 220 is not performed by client 110 when client 110 transitions from state 320 to state 310 or state 330 to state 310.

In an embodiment where records about which software programs have been removed or uninstalled by the user of client 110 are stored in BIOS 110, when performing step 220, OS component program 134 may send, to server 180, information that uniquely identifies client 110 as well as what software programs have been deleted or uninstalled from client 110. Note that, for privacy reasons, the user of client 110 may not be identified in this communication from client 110 to server 180.

In another embodiment where records about which software programs have been removed or uninstalled by the user of client 110 are stored at server 180, when performing step 220, OS component program 134 may send, to server 180, information that uniquely identifies client 110 without identifying, for privacy reasons, the user of client 110.

In step 230, server 180 sends, to client 110, data that identifies what, if any, additional software programs, configuration settings, and/or multimedia content client 110 should install as well as any data necessary for client 110 to install the software programs, configuration settings, and/or multimedia content which client 110 should install. Server 180 may maintain records that associate, with each of a plurality of clients in system 100, an installation profile. In performing step 230, server 180 may consult the installation profile associated with client 110. The installation profile for a client identifies those software programs, configuration changes, and/or multimedia content which the client should have installed.

When server 180 determines what additional software programs, configuration changes, and/or multimedia content client 110 should install, server 180 will consider what software programs, configuration changes, and/or multimedia content have been legitimately (i.e., the disable key was provided by the user) removed, changed, or uninstalled by the user of client 110. Server 180 will not require client 110 to install any software program or multimedia content identified by its associated installation profile if the user of client 110 has legitimately removed or uninstalled the software program or multimedia content. Similarly, if a user has made a legitimate change to a configuration setting (the request to change the configuration setting was accompanied by a valid disable key), then server 180 may not require client 110 to change the configuration setting as indicated in the installation profile.

If the owner of client 110 wishes to update which software programs, configuration settings, and/or multimedia content should be installed or implemented on client 110, then the owner would contact server 180 (for example, via a GUI such as a web page) and update the installation profile for client 110 to include the particular software program, configuration settings, and/or multimedia content. Additionally, the owner would provide, to server 180, the data which server 180 would need to communicate to client 110 to enable client 110 to install or implement the particular software program, configuration settings, and/or multimedia content. In this way, the owner of a plurality of clients may update the installation profile associated with each of the plurality of clients to quickly and efficiently update the software programs, configuration settings, and/or multimedia content installed on each of the plurality of clients. Embodiments of the invention may provide a GUI to allow the owner to update the installation profile of multiple clients at once.

In an embodiment, the OEM (or original equipment manufacturer) of client 110 may also update the installation profile for client 110. As shall be explained in further detail below, the OEM may wish to make a change to client, such as update the particular software programs installed as OEMware on client 110. To perform this task, the OEM would contact server 180 and update the installation profile associated with client 110 to reflect the desired set of OEMware.

While embodiments of the invention have chiefly been described with reference to installing a software program on client 110, other embodiments of the invention may be employed to update the configuration settings of a software program already installed on client 110. For example, the data sent from server 180 to client 110 in step 230 may identify new configuration settings for an installed software program. Upon receiving such data, OS component program 134 may update the software program installed on client 110 with the new configuration settings. In such an embodiment, the software profile associated with each client may be updated to describe configuration settings for each software program to be installed on a client.

Further, while embodiments of the invention have chiefly been described with reference to installing a software program on client 110, other embodiments of the invention may be employed to uninstall a software program already installed on client 110. For example, the data sent from server 180 to client 110 in step 230 may identify a particular software program to be removed or uninstalled from client 110. Upon receiving such data, OS component program 134 may remove or uninstall the software program from client 110. In such an embodiment, if client 110 has a software program installed thereon which is not included in the software profile, stored on server 180, associated with client 110, then server 180 indicates that the software program should be removed or uninstalled from client 110.

### Securely Storing the Injector Module in the Bios

As software programs may be deleted, uninstalled, or disabled from client 110 in an unauthorized manner by a malicious user, it is advantageous to provide mechanisms which make it hard for a party to circumvent, disable, or disengage the ability of embodiments of the invention to install software that should be installed on client 110.

BIOS 120 is responsible for booting client 110 and starting client 110 and its components, such as CPU and memory. BIOS 120 has two portions, a boot portion and a runtime portion. The boot portion of BIOS 120 is responsible for activities involved in booting client 110, while the runtime portion of BIOS 120 is responsible for ongoing activities after client 110 has booted. In an embodiment, injector module 122 communicates and interacts with the runtime portion of BIOS 120.

By implementing injector module 122 within BIOS 120 of each client of system 100, it is hard for a party to circumvent, disable, or disengage the protection offered by embodiments of the invention. It may be advantageous to secure injector module 122 from tampering and interference from unauthorized users. In an embodiment, BIOS 120, and therefore injector module 122, may be stored on a special microchip located on the motherboard of client 110. The microchip is designed to ensure that BIOS 120 cannot be accessed by unauthorized parties. To achieve this goal, the microchip may be designed such that data stored on the microchip is (a) encrypted and (b) cannot be overwritten.

In an embodiment, injector module 122 securely stores certain types of data in a manner that preserves the data through power cycles, disk re-formatting, software reinstallation, BIOS reflashing, and the like. For this purpose, injector module 122 may maintain a small database, referred to as a Secure Data Memory (SDM), in the BIOS Flash Memory (EEPROM). Information stored in the SDM may includes information about client provisioning from the manufacturing process, bootstrap program 132 installation process, and injector module 122 registration process with server 180, including but not limited to a unique client identifier generated by server 180, and password(s) for authentication and session keys, a server identifier. Additionally, the SDM may store information about the software programs that have been legitimately deleted or removed from client 110 by an authorized user as well as information about the software programs that have been deleted or removed from client 110 in an illegitimate manner.

To maintain security, data in the SDM must be protected from intentional and unintended disclosure. Injector module 122 may encrypt data stored in the SDM which must not be disclosed. Similarly, none of the data stored in the SDM should be capable of being altered by a rogue software program. The BIOS Flash Memory meets these requirements, as it is a secure data storage area which may only be accessed and altered by authorized BIOS programs.

SDM may be implemented in a reserved area of Flash Memory and afforded the protection that it offers. Flash Memory is different from normal RAM memory in two significant ways. First, memory access is much slower. Second, there are a finite number of times that flash memory can be rewritten. To compensate, certain flash memory microchips have built-in means for “moving” data to different areas of memory. In an embodiment, injector module 122 may further address the limit on the number of times flash memory may be rewritten by allocating multiple records, and when the limit is about to be reached in a first record, the contents of the first record are copied to a second record and the current-record pointer is updated to reference the second record.

In an embodiment, to ensure that injector module 122 is implemented such that (a) injector module 122 is prevented from being overwritten and/or deleted, and (b) injector module 122 encrypts data to prevent unauthorized parties from reading the code and/or data that comprises injector module 122, injector module 122 may be implemented using an approach referred to as “SecurePhlash,” which is described in U.S. patent Ser. No. 11/026,813, entitled “Secure Firmware Update,” filed by Andrew Cottrell et al. on Dec. 28, 2004, the contents of which are herein incorporated by reference as if fully set forth herein. SecurePhlash may be used to ensure that injector module 122 cannot be disabled without manually altering or changing the physical components of the client upon which injector module 122. SecurePhlash requires that a user provide not only the contents (i.e., bit patterns) to be reflashed, but the proper certificates of signature to ensure that the BIOS can only be reflashed by authorized parties. Passing this hurdle allows re-flashing to process in a system/chip mode that is only available to the BIOS, and thus, applications are unable to gain the necessary access to overwrite the contents of a portion of Flash Memory. SecurePhlash also provides the capability for excluding blocks of BIOS Flash Memory from being re-flashed, thereby providing a one-time only flash capability.

In another embodiment of the invention, BIOS 120, and by extension injector module 122, may be encrypted using a published specification called Trusted Platform Module (TPM) by Trusted Computing Group. Other embodiments of the invention may employ different approaches for encrypting data in the BIOS, as SecurePhlash, TPM, or other methods known to those skilled in the art may be employed.

### Types of Software and Data which May be Installed

Embodiments of the invention may be used to install a wide variety of different types of software, data, configuration settings, and multimedia content. To illustrate, embodiments may be used to install driver updates, software updates, and/or updates to BIOS 120 or operating system 130.

Another example of the types of software which may be installed by embodiments is OEMware. As used herein, OEMware is a term used to refer to any software program provided by the manufacturer of client 110, or the Original Equipment Manufacturer (or “OEM”) which is installed on client 110 at time of manufacture of client 110. OEMware may also be known as “after market software.” OEMs typically are compensated by the providers of the software programs installed as OEMware on a client for the service of installing the software programs on the client. Thus, it is advantageous for the manufacturer of client 110 to be able to verify and ensure that OEMware is currently installed on client 110, as the manufacturer of client 110 may receive compensation from various software vendors providing the software programs installed as OEMware on client 110.

Over time, the manufacturer of client 110 may wish to change or update the particular set of software programs installed as OEMware on client 110. For example, software programs A, B, and C may be installed as OEMware on client 110. However, the manufacturer of client 110 may wish to update client 110 so that client 110 has software programs A, B, D, and E installed. The manufacturer of client 110 may update the installation profile for client 110 stored by server 180 to reflect the revised set of software programs desired to be installed as OEMware on client 110.

Enterprise-ware is another example of the type of software which may be installed by embodiments. As used herein, enterprise-ware is a term used to refer to any software program installed on client 110 by the owner of client 110. For example, typically a company or other large organization may wish to install a standard set of software programs on a large number of laptops or computerized devices, such as anti-virus software, word processing applications, spreadsheet applications, and the like. In this way, a company may ensure the needs of its employees are met while also ensuring the software installed on the clients may be supported by the IT department of the company.

Other examples of what may be installed using embodiments of the invention include the “default search engine” and other configuration settings of the one or more web browsers that are present on the computer. This is valuable because the choice of what web browser is configured on a computer system is often the basis of a revenue sharing arrangement between the search engine operator and the computer distributor or manufacturer.

Other examples of the type of software which may be installed and/or configured using embodiments of the invention include software directed towards security, asset tracking and inventory, user applications, operating system and application program updates, and virus protection.

As another example, data and or configuration settings may be downloaded, installed, or updated using embodiments of the invention. For example, if a profile manager sends information about client 110 to server 180, and if a rule has been defined in an installation profile for client 110 which indicates client 110 is to download a data file and/or make a configuration change to hardware or software of client 110, then embodiments of the invention may download such information if the rule so instructs (the rule may specify one or more conditions which must be satisfied in order to be enacted). In this way, the vendor or OEM of client 110 may ensure that certain hardware or software on client 110 remains optimized for the current use of the user of client 110. To illustrate a specific example, if a software installation profile indicates that the configuration settings of a search engine should be adjusted if a condition is met, and if the information received from a profile manager on client 110 indicates that the condition is met, then embodiments may send, from server 180 to client 110, data enabling client 110 to update the configuration settings of the search engine in accordance with the software installation profile. Embodiments of the invention may enable updates to configuration settings to be made by downloading the configuration changes directly or by downloading a program that applies the configuration changes to client 110.

Additionally, embodiments of the invention may be used to check for the presence of electronic content (such as purchased music, books, video, etc.), and subsequently download such content to client 110 if the client 110 does not currently have a copy of the electronic content. For example, a profile manager could monitor a set of data describing a list of purchased media content items, and if purchased media content does not reside on client (e.g., a purchased television show, movie, music, or electronic book becomes available), then server 180 may itself, or instruct another entity, to send the purchased media content to client 110. Any type of multimedia content may be obtained by the client in this fashion, including, but not limited to, video, music, advertisements, games, and books. Similarly, OS component program 134 may be configured to delete any multimedia content which has not been legitimately obtained or for which a rule in an association installation profile indicates should be deleted.

### Deployment Via a Plug-In

Embodiments of the invention may implement injector module 122 as a plug-in. In such an embodiment, injector module 122 would need to be designed such that it may be “plugged-in” or installed in the particular BIOS implementing BIOS 120. For example, injector module 122 would need to configured such that step 220 of FIG. 2 is performed anytime BIOS 120 indicates the client is transitioning from state 340 of FIG. 3 to state 310. In an embodiment, injector module 122 may be implemented as a plug-in using any standard or industry-accepted approach or framework for implementing plug-ins, such as, but not limited to, the Extensible Firmware Interface (EFI) from Intel Corporation and the Unified Extensible Firmware Interface (UEFI) version 2.0 or later by the Unified EFI Forum. For example, at the hardware level, the UEFI specification provides developers a standard interface so they can create a firmware driver plug-in to handle their specific boot hardware. System developers may then take UEFI-based firmware and add the drivers for their hardware without needing to do any additional program development.

### Implementing Mechanisms

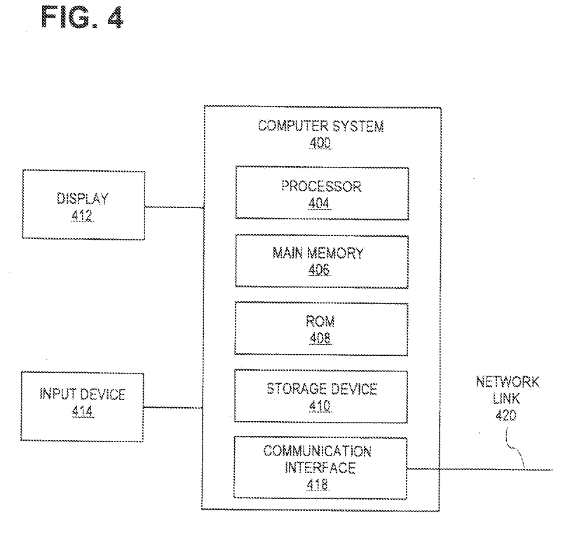

In an embodiment, client 110 as well as any client within system 100 may be implemented using a computer system. FIG. 4 is a block diagram that illustrates a computer system 400 upon which an embodiment of the invention may be implemented. In an embodiment, computer system 400 includes processor 404, main memory 406, ROM 408, storage device 410, and communication interface 418. Computer system 400 includes at least one processor 404 for processing information. Computer system 400 also includes a main memory 406, such as a random access memory (RAM) or other dynamic storage device, for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device for storing static information and instructions for processor 404. A storage device 410, such as a magnetic disk or optical disk, is provided for storing information and instructions.

Computer system 400 may be coupled to a display 412, such as a cathode ray tube (CRT), a LCD monitor, and a television set, for displaying information to a user. An input device 414, including alphanumeric and other keys, is coupled to computer system 400 for communicating information and command selections to processor 404. Other non-limiting, illustrative examples of input device 414 include a mouse, a trackball, or cursor direction keys for communicating direction information and command selections to processor 404 and for controlling cursor movement on display 412. While only one input device 414 is depicted in FIG. 4, embodiments of the invention may include any number of input devices 414 coupled to computer system 400.

Embodiments of the invention are related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement embodiments of the invention. Thus, embodiments of the invention are not limited to any specific combination of hardware circuitry and software.

The term “machine-readable storage medium” as used herein refers to any medium that participates in storing instructions which may be provided to processor 404 for execution. Such a medium may take many forms, including but not limited to, non-volatile media and volatile media. Non-volatile media includes, for example, optical or magnetic disks, such as storage device 410. Volatile media includes dynamic memory, such as main memory 406.

Non-limiting, illustrative examples of machine-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read.

Various forms of machine readable media may be involved in carrying one or more sequences of one or more instructions to processor 404 for execution. For example, the instructions may initially be carried on a magnetic disk of a remote computer. The remote computer can load the instructions into its dynamic memory and send the instructions over a network link 420 to computer system 400.

Communication interface 418 provides a two-way data communication coupling to a network link 420 that is connected to a local network. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through a local network to a host computer or to data equipment operated by an Internet Service Provider (ISP).

Computer system 400 can send messages and receive data, including program code, through the network(s), network link 420 and communication interface 418. For example, a server might transmit a requested code for an application program through the Internet, a local ISP, a local network, subsequently to communication interface 418. The received code may be executed by processor 404 as it is received, and/or stored in storage device 410, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A machine-readable storage medium storing one or more sequences of instructions, which when executed, cause:
an injector module, executing within the basic input/output system (BIOS) of a client, determining whether a bootstrap program is stored by an file system provided by an operating system of the client; and
in response to the injector module determining that the bootstrap program is not stored by the file system, the injector module installing the bootstrap program on the file system,
wherein the bootstrap program is configured to determine whether an operating system component program is stored by the file system, wherein the operating system component program is one or more software modules that are configured to (a) monitor actions of a user of the client to determine whether the actions include any legitimate change to a software program installed on the client, and (b) install a set of one or more software programs at the request of a server.

2. The machine-readable storage medium of claim 1, wherein a legitimate change to the software program is a request to uninstall the software program which accompanies a disable key.

3. The machine-readable storage medium of claim 1, wherein a legitimate change to the software program is a request to change a configuration setting of the software program which accompanies a disable key.

4. The machine-readable storage medium of claim 1, wherein the injector module is a plug-in which has been installed in the BIOS of the client.

5. A machine-readable storage medium storing one or more sequences of instructions for, which when executed, cause:
an operating system storing an operating system component program configured to (a) monitor actions of a user of a client to determine whether the actions include any legitimate change to a software program installed on the client, and (b) install a set of one or more software programs, configuration changes, or multimedia content at the request of a server; and
upon the operating system component program determining that the user has performed a change to a software program installed on the client, the operating system component program persistently storing a record that identifies the change.

6. The machine-readable storage medium of claim 5, wherein the operating system component program determines the change is a legitimate change because the user submitted a disable key to the operating system component program.

7. The machine-readable storage medium of claim 5, wherein the operating system component program persistently stores the record in the basic input/output system (BIOS) of the client.

8. The machine-readable storage medium of claim 5, wherein the operating system component program persistently stores the record by communicating data describing the record over a communications link to a server.

9. The machine-readable storage medium of claim 5, wherein execution of the one or more sequences of instructions further cause:
the operating system component program sending a message to a server requesting the server to identify a set of software programs which the client should install.

10. The machine-readable storage medium of claim 9, wherein the message identifies the client but does not identify the user of the client.

11. The machine-readable storage medium of claim 9, wherein the message identifies changes made by the user of the client to software programs installed on the client.

12. The machine-readable storage medium of claim 5, wherein the operating system component program is further configured to change a configuration setting of a software program installed on the client in response to a request from the server.

13. A method for updating an operating system, comprising:
an injector module, executing within a basic input/output system (BIOS) of a client, determining whether a bootstrap program is stored by a file system provided by an operating system of the client; and
in response to the injector module determining that the bootstrap program is not stored by the file system, the injector module installing the bootstrap program on the file system,
wherein the bootstrap program is configured to determine whether an operating system component program is stored by the file system, wherein the operating system component program is one or more software modules that are configured to (a) monitor actions of a user of the client to determine whether the actions include any legitimate change to a software program installed on the client, and (b) install a set of one or more software programs at the request of a server.

14. The method of claim 13, wherein a legitimate change to the software program is a request to uninstall the software program which accompanies a disable key.

15. The method of claim 13, wherein a legitimate change to the software program is a request to change a configuration setting of the software program which accompanies a disable key.

16. The method of claim 13, wherein the injector module is a plug-in which has been installed in the BIOS of the client.

17. A method for updating a client, comprising:
an operating system storing an operating system component program configured to (a) monitor actions of a user of the client to determine whether the actions include any legitimate change to a software program installed on the client, and (b) install a set of one or more software programs, configuration changes, or multimedia content at the request of a server; and
upon the operating system component program determining that the user has performed a change to a software program installed on the client, the operating system component program persistently storing a record that identifies the change.

18. The method of claim 17, wherein the operating system component program determines the change is a legitimate change because the user submitted a disable key to the operating system component program.

19. The method of claim 17, wherein the operating system component program persistently stores the record in a basic input/output system (BIOS) of the client.

20. The method of claim 17, wherein the operating system component program persistently stores the record by communicating data describing the record over a communications link to a server.

21. The method of claim 17, wherein execution of the one or more sequences of instructions further cause:
the operating system component program sending a message to a server requesting the server to identify a set of software programs which the client should install.

22. The method of claim 21, wherein the message identifies the client but does not identify the user of the client.

23. The method of claim 21, wherein the message identifies changes made by the user of the client to software programs installed on the client.

24. The method of claim 17, wherein the operating system component program is further configured to change a configuration setting of a software program installed on the client in response to a request from the server.

25. The machine-readable storage medium of claim 5, wherein at least one of the one or more software programs, when executed at the client, updates a configuration setting of (a) a software application residing on the client or (b) a hardware component of the client.

26. The method of claim 17, wherein at least one of the one or more software programs, when executed at the client, updates a configuration setting of (a) a software application residing on the client or (b) a hardware component of the client.

27. The machine-readable storage medium of claim 5, wherein the multimedia content comprises one or more of: video, music, advertisements, games, and books.

28. The method of claim 17, wherein the multimedia content comprises one or more of: video, music, advertisements, games, and books.

29. A machine-readable storage medium storing one or more sequences of instructions, which when executed, cause:
an operating system, executing on a client, comprising an operating system component program that includes one or more profile managers, wherein each of the one or more profile managers is configured to obtain information about characteristics of the client and subsequently communicate the information about the characteristics of the client to a server, and wherein the operating system component program is configured to install a set of one or more software programs, configuration changes, or multimedia content, on the client, at the request of the server; and
upon the operating system component program determining that a user, of the client, has performed a legitimate action on the client, the operating system component program persistently storing a record that identifies the legitimate action,
wherein at least one profile manager, of the one or more profile managers, monitors the records identifying legitimate actions performed by the user.

30. The method for updating a client, comprising:
an operating system, executing on the client, comprising an operating system component program that includes one or more profile managers, wherein each of the one or more profile managers is configured to obtain information about characteristics of the client and subsequently communicate the information about the characteristics of the client to a server, and wherein the operating system component program is configured to install a set of one or more software programs, configuration changes, or multimedia content, on the client, at the request of the server; and
upon the operating system component program determining that a user, of the client, has performed a legitimate action on the client, the operating system component program persistently storing a record that identifies the legitimate action,
wherein at least one profile manager, of the one or more profile managers, monitors the records identifying legitimate actions performed by the user.
